(19) United States
(12) Patent Application Publication
(10) Pub. No.: US 2022/0084122 A1
(43) Pub. Date: Mar. 17, 2022

(54) METHOD FOR EVALUATING RISK MEASURES FOR PORTFOLIO AND PORTFOLIO EVALUATING DEVICE

(71) Applicant: National Yang Ming Chiao Tung University, Hsinchu City (TW)

(72) Inventor: Huei-Wen TENG, Hsinchu City (TW)

(21) Appl. No.: 17/447,060

(22) Filed: Sep. 7, 2021

(30) Foreign Application Priority Data
Sep. 11, 2020 (TW) 109131338

(51) Int. Cl. G06Q 40/06; G06Q 30/02

(52) U.S. Cl. CPC G06Q 40/06; G06Q 30/0201

(57) ABSTRACT

The Value-at-Risk and expected shortfall are risk measures used for evaluating capital retention requirements for banks as indicated in the Basel accords. Because the development of more sophisticated financial contracts and realistic econometric models, calculating these measures accurately and efficiently is challenging. Because these measures are related to rare event simulation, this project aims at proposing a useful importance sampling scheme with exponential tiling for calculating the tail probabilities and tail expectations of the portfolio loss. The portfolio loss is approximated by the delta-gamma method where underlying returns are assumed to be heavy-tailed with the multivariate t distributions. The optimal tilting parameter is determined by minimizing the variance of the importance sampling estimator and can be searched easily by an automatic stochastic fixed-point-Newton algorithm. The numerical experiments show the superiority of our method over the standard Monte Carlo simulation in terms of variances and computation times.

### CROSS-REFERENCE TO RELATED APPLICATION

This application claims priority to Taiwan Application Serial Number 109131338, filed on Sep. 11, 2020, which is herein incorporated by reference in its entirety.

### BACKGROUND

### Field of Invention

The present disclosure relates to an electronic device and a method. More particularly, the present disclosure relates to a method for evaluating risk measures for portfolio and a portfolio evaluating device.

### Description of Related Art

With the rapid development and gigantic size of financial derivative markets, it is of considerable importance to manage a portfolio consisted of financial derivatives.

According to the Basel Accords, the Value-at-Risk and expected shortfall are important risk measures for calculating the minimum capital requirement to avoid the market risk.

### SUMMARY

One aspect of the present disclosure provides a method for evaluating risk measures for a portfolio. The method for evaluating risk measures for the portfolio includes steps of: converting a portfolio loss of the portfolio by a delta-gamma approximation as a quadratic function of t-distributed risk factors; converting a multidimensional t distribution as a ratio of a multidimensional normal distribution and a gamma distribution which are independent of each other; using a first tilting parameter and a second tilting parameter for the gamma distribution and the multidimensional normal distribution, respectively, to obtain an importance sampling estimator; calculating a variance of the importance sampling estimator; minimizing the variance of the importance sampling estimator to obtain the first tilting parameter and the second tilting parameter; calculating a financial risk measure, wherein the financial risk measure includes a Value-at-Risk and an Expected Shortfall; and using an importance sampling method according to the first tilting parameter and the second tilting parameter.

Another aspect of the present disclosure provides a portfolio evaluating device. The portfolio evaluating device includes a memory and a processor. The memory is configured to store an instruction. The processor is configured to execute the instruction in the memory so as to complete following steps of: converting a portfolio loss by a delta-gamma approximation as a quadratic function of t-distributed risk factors; converting a multidimensional t distribution as a ratio of a multidimensional normal distribution and a gamma distribution which are independent of each other; using a first tilting parameter and a second tilting parameter for the gamma distribution and the multidimensional normal distribution, respectively, to obtain an importance sampling estimator; calculating a variance of the importance sampling estimator; minimizing the variance of the importance sampling estimator to obtain the first tilting parameter and the second tilting parameter; calculating a financial risk measure, wherein the financial risk measure includes a Value-at-Risk and an Expected Shortfall; and using an importance sampling method according to the first tilting parameter and the second tilting parameter.

It is to be understood that both the foregoing general description and the following detailed description are by examples, and are intended to provide further explanation of the present disclosure as claimed.

### BRIEF DESCRIPTION OF THE DRAWINGS

The present disclosure can be more fully understood by reading the following detailed description of the embodiment, with reference made to the accompanying drawings as follows:

FIG. 1 depicts a schematic diagram of a portfolio evaluating device according to one embodiment of the present disclosure; and

FIG. 2 depicts a flow chart of a method for evaluating risk measures for portfolio according to one embodiment of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

The terminology used herein is for the purpose of describing particular example embodiments only and is not intended to be limiting of the present disclosure. As used herein, the singular forms “a,” “an” and “the” are intended to include the plural forms as well, unless the context clearly indicates otherwise.

Furthermore, it should be understood that the terms, “comprising”, “including”, “having”, “containing”, “involving” and the like, used herein are open-ended, that is, including but not limited to.

The terms used in this specification and claims, unless otherwise stated, generally have their ordinary meanings in the art, within the context of the disclosure, and in the specific context where each term is used. Certain terms that are used to describe the disclosure are discussed below, or elsewhere in the specification, to provide additional guidance to the practitioner skilled in the art regarding the description of the disclosure.

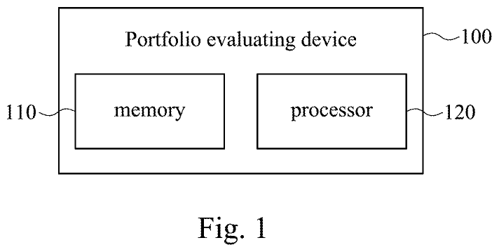

FIG. 1 depicts a schematic diagram of a portfolio evaluating device according to one embodiment of the present disclosure. The portfolio evaluating device 100 includes a memory 110 and a processor 120.

In some embodiments, the memory 110 includes a Flash memory, a Hard Disk Drive (HDD), a Solid State drive (SSD), a Dynamic Random Access Memory (DRAM) or a Static Random Access Memory (SRAM). In some embodiments, the memory 110 can be configured to store instructions.

In some embodiments, the processor 120 includes but is not limited to a single processor and an integration of multiple microprocessors, for example, a Central Processing Unit (CPU) or a Graphic Processing Unit (GPU). The processor (or the microprocessors) is coupled to the memory 110. Therefore, the processor 120 can read instructions from the memory 110, and execute a specific application so as to calculate an expected shortfall and a Value-at-Risk of a portfolio according to instructions.

A Value-at-Risk is defined as a percentile of a single asset or asset a portfolio after a market economy changes under a specific period. An expected shortfall is defined as the conditional expected value of loss under a condition that a loss is greater than a given value. In other words, an expected shortfall is an average of an end of a right tail of a probability distribution of loss.

In some embodiments, assume that X follows the d-dimensional t distributions with degrees of freedom v, denoted as t_{d,v}. Let Z follows the d-dimensional standard normal distribution, denoted as N_{d}(0, II). If X has the t distribution, t_{d,v}, it can be expressed as follows:

X [symbol] WZ formula 1

In formula 1, W is equal to \sqrt{v/Y}, where Y has the chi-squared distribution with degrees of freedom v, denoted as Xᵥ². Y and Z are independent of each other. Therefore, X can be represented by Y and Z as follows:

$$X {=}^{def} \frac{Z}{\sqrt{Y / v}} \qquad formula 2$$

In some embodiments, a function [symbol] (X) is rewritten by a function [symbol] (Y,Z) so as to be substituted into the formula 2. The formula 2 is rewritten as follow:

$$E [ ( X ) ] = E [ ( \frac{z}{\sqrt{Y / v}} ) ] = E [ ( Y , Z ) ] \qquad formula 3$$

In some embodiments, an important step of importance sampling is to determine a different sampling probability measure Q, which is configured to adjust an original estimator. Since the aforementioned Y and Z are within exponential family, we consider an exponential tilting importance sampling for its tractability in mathematics. In a general setting, let ξ=(ξ₁, . . . , ξ_{d})′ be a random vector under an original probability measure P. A moment generating function ξ is assumed to exist and be denoted by Ψ(θ)=E[e^{θ′ξ}].

Then, θ=(θ₁, . . . , θ_{d})′ is a multidimensional tilting parameter. An exponential tilting measure Q_{θ} is defined with respect to the original probability measure P as follows:

$$\frac{{dQ}_{θ}}{dP} = \frac{{e}^{{θ}^{′} ξ}}{E [ {e}^{{θ}^{′} ξ} ]} = {e}^{{θ}^{′} ξ - ψ ( θ )} \qquad formula 4$$

In formula 4, a cumulant function ψ(θ)=log Ψ(θ) is the natural logarithm of the moment generating function of ξ.

Then, with a change of measure, we obtain the following equation

$$E [ ℘ ( ξ ) ] = \int ℘ ( ξ ) dP = \int ℘ ( ξ ) \frac{dP}{{dQ}_{θ}} {dQ}_{θ} = {E}_{{Q}_{θ}} [ ℘ ( ξ ) \frac{dP}{{dQ}_{θ}} ] \qquad formula 5$$

An importance sampling estimator is detailed as below:

$$\begin{matrix}℘ ( ξ ) \frac{dP}{{dQ}_{θ}} = ℘ ( ξ ) {e}^{- {θ}^{′} ξ + ψ ( θ )} & formula 6 \\ \frac{dP}{{dQ}_{θ}} = {e}^{- {θ}^{′} ξ + ψ ( θ )} & formula 7\end{matrix}$$

In formula 6, the moment generating function of ξ is under a distribution P. Formula 7 is called as the importance sampling estimator weight or the Radon-Nikodym derivative. The importance sampling estimator shown in the formula 5 is unbiased. Probability distributions under the aforementioned Y and Z will be verified in following paragraphs.

In some embodiments, Y is assumed to follow Xᵥ² under the probability measure P. The tilting parameter for the gamma distribution η belongs to a set [symbol] . Therefore, Y follows the gamma distribution with the shape parameter

$$( \frac{v}{2} )$$

and scale parameter

$$( \frac{2}{1 - 2 η} ) ,$$

denoted by

$$Γ ( \frac{v}{2} , \frac{2}{1 - 2 η} )$$

under the probability measure Q_{η}.

In some embodiments, Z is assumed follow N_{d}(0, II) under the probability measure P. The second tilting parameter ϑ=(ϑ₁, . . . , ϑ_{d})′ belongs to a set Therefore, Z follows N_{d}(ϑ, II) under the probability measure Q_{ϑ}.

In some embodiments, the tilting parameter η for the gamma distribution Y belongs to the set and the tilting parameter for the d-dimensional standard normal distribution Z belongs to the set [symbol] ^{d}. The exponential tilting importance sampling estimator is transformed through the formula 3 and is detailed as below:

[symbol]

_{η,ϑ}(Y,Z)= [symbol] (Y,Z)e^{-ηy-ϑZ-vlog(1-2η)/2+ϑ′ϑ/2} formula 8

In formula 8, under a probability measure Q_{η,ϑ}, Y follows

$$Γ ( \frac{v}{2} , \frac{2}{1 - 2 η} ) ,$$

and Z follows N_{d}(19, II). In addition, Y and Z are independent of each other. Furthermore, [symbol] _{η,ϑ}(Y,Z) is unbiased because E_{Q}[ [symbol] _{η,ϑ}(Y,Z)]=E[ [symbol] (X)] is proved. In some embodiments, e^{-ηy-ϑz-vlog(1-2η)/2+ϑ′ϑ/2} is the importance sampling weight.

In some embodiments, in order to find out the best tilting parameters, the variance of the importance sampling estimator must be minimized. A calculation formula of the variance is represented as below:

var( [symbol] _{η,ϑ}(Y,Z))=E_{Q}[ [symbol] _{η,ϑ}²(Y,Z)]−(E_{Q}[ [symbol] _{η,ϑ}(Y,Z)])² formula 9

Since the importance sampling estimator is unbiased, minimizing the variance of the importance sampling estimator is equal to minimizing a second moment of the importance sampling estimator. For simplicity, we define

G(η,ϑ)=E_{Q}[ [symbol] _{η,ϑ}²(Y,Z)] formula 10

Formula 10 is simplified by standard algebra to be an expected value under the probability measure P. Formula 10 equals

E[ [symbol] ²(Y,Z)e^{-ηy-ϑz-vlog(1-2η)/2+ϑ′ϑ/2}] formula 11

In formula 11, under the probability measure P, Y follows

$$Γ ( \frac{v}{2} , \frac{2}{1 - 2 η} ) ,$$

and Z follows N_{d}(0, II). In addition, Y and Z are independent of each other.

In some embodiments, a function G(η,ϑ) is convex function and includes a unique minimizer. In some embodiments, a conjugate probability measure 1:1 is defined as [symbol] and is represented as below:

$$\frac{d \overline{Q}}{dP} = \frac{{℘}^{2} ( Y , Z ) {e}^{- η y - {ϑ}^{′} Z}}{E [ {℘}^{2} ( Y , Z ) {e}^{- η y - {ϑ}^{′} Z} ]} \qquad formula 12$$

In some embodiments, the best tilting parameter η and ϑ are configured to minimize the variance of the importance sampling estimator to be a solution of a (d+1)-dimensional non-linear system. The optimal tilting parameter η and ϑ satisfy the following system of non-linear equations:

$$\begin{matrix}\frac{v}{1 - 2 η} = {E}_{\overline{Q}} [ Y ] & formula 13 \\ ϑ = {E}_{\overline{Q}} [ Z ] & formula 14\end{matrix}$$

The conjugate probability measure Q shown in formula 13 and formula 14 is defined in formula 12.

In some embodiments, formula 13 and formula 14, solutions the optimal tilting parameters η and ϑ need to satisfy, which involve expected values without closed-form formulas. To overcome these numerical difficulties, the present disclosure provides a stochastic fixed-point-Newton algorithm to search the two tilting parameters η and ϑ that satisfy formula 13 and formula 14.

In some embodiments, multidimensional t distribution can be written as a combination of a multidimensional normal distribution and a gamma distribution. The gamma distribution is a one-dimensional distribution.

In some embodiments, at first, the first optimal tilting parameter η under the gamma distribution is solved by a fixed-point iteration for the best solution. In addition, the second optimal tilting parameter ϑ under the multidimensional normal distribution is solved by a Newton method.

In some embodiments, in order to search the first tilting parameter η, the fixed-point iteration is applied. The fixed-point iteration is configured to update the first tilting parameter η and satisfy the formula 13. The formula 13 is represented as below:

$$η = \frac{1}{2} ( 1 - \frac{v}{{E}_{\overline{Q}} [ Y ]} ) \qquad formula 15$$

In some embodiments, in order to apply the first tilting parameter η into an iteration of the present disclosure. Please refer to the formula 15. The fixed-point iteration is further rewritten as below:

$${η}^{j + 1} = \frac{1}{2} ( 1 - \frac{v}{{E}_{{\overline{Q}}^{( j )}} [ Y ]} ) \qquad formula 16$$

In some embodiments, in order to apply the second tilting parameter ϑ into the iteration of the present disclosure. By modifying Newton's method and substituting a function, a function g(ϑ)=(g₁(ϑ), . . . , g_{d}(ϑ))′ is defined so as to rewrite formula 14 as below:

g(ϑ)=ϑ−E_{Q̅}[Z] formula 17

In some embodiments, in order to solve formula 17, we apply the Newton method and calculate the Jacobian, which is a square matrix. Then, the Jacobian of formula 17 is as below:

J_{ϑ}= [symbol] −E_{Q̅}[Z]E_{Q̅}[Z]′+E_{Q̅}[ZZ′] formula 18

In some embodiments, the iterative formula to find the second tilting parameter using the Newton's method is as follows:

ϑ^{(j+1)}=ϑ^{(j)}− [symbol] g(ϑ^{(j)}) formula 19

In some embodiments, based on the above embodiments, we need to calculate expected values: E_{Q̅}[Y], E_{Q̅}[Z] and E_{Q̅}[ZZ′] in formulas 16, 17, 18. These expectations can be calculated using a Naïve importance sampling method:

$$\begin{matrix}{E}_{\overline{Q}} [ Y ] = \frac{{E}_{\overline{p}} [ {Y ℘}^{2} ( Y , Z ) {e}^{- η y - {ϑ}^{′} Z - \overline{η} y - \overline{{ϑ}^{′}} Z} ]}{{E}_{\overline{p}} [ {℘}^{2} ( Y , Z ) {e}^{- η y - {ϑ}^{′} Z - {ϑ}^{′} Z - \overline{η} y - \overline{{ϑ}^{′}} Z} ]} & formula 20 \\ {E}_{\overline{Q}} [ Z ] = \frac{{E}_{\overline{p}} [ {Z ℘}^{2} ( Y , Z ) {e}^{- η y - {ϑ}^{′} Z} ]}{{E}_{\overline{p}} [ {℘}^{2} ( Y , Z ) {e}^{- η y - {ϑ}^{′} Z} ]} & formula 21 \\ {E}_{\overline{Q}} [ {ZZ}^{′} ] = \frac{{E}_{\overline{p}} [ {ZZ}^{′} {℘}^{2} ( Y , Z ) {e}^{- η y - {ϑ}^{′} Z} ]}{{E}_{\overline{p}} [ {℘}^{2} ( Y , Z ) {e}^{- η y - {ϑ}^{′} Z} ]} & formula 22\end{matrix}$$

In some embodiments, we calculate the expected values in formulas 20 to 22 as intermediate steps in order to iterative search the optimal tilting parameters through formulas 16 and 19.

In some embodiments, in order to terminate the iteration, a sum of squared errors of multidimensional non-linear equations is calculated. Then, the sum of squared errors is applied into the iteration. The sum of squared errors is defined that a difference between an original test sample and a new sample. The smaller the sum of squared errors is, the more accurate the optimal titling parameters are. The sum of squared errors is as below:

$${SSE}^{( j )} = {( \frac{v}{1 - 2 {η}^{( j + 1 )}} - {E}_{\overline{Q}} [ Y ] )}^{2} + {( {ϑ}^{( j + 1 )} - {E}_{\overline{Q} ( {j}^{′} )} [ Z ] )}^{′} ( {ϑ}^{( j + 1 )} - {E}_{\overline{Q} ( {j}^{′} )} [ Z ] ) \qquad formula 23$$

In some embodiments, a portfolio value is assumed to be exposed underlying a plurality of risk factors over a period of time. Therefore, the portfolio value is represented as V(t, S). The V is the portfolio value at time t. The S is the vector of risk factors, and is represented as S=(S1, . . . , Sd), d in the function of the risk factors is a positive integer. ΔS is denoted as changes in underlying risk factors (e.g. the plurality of risk factors S) are from a current time t to an end of the horizon time t+Δt. L is a random variable to denote a portfolio's profit and loss, is approximated by the delta-gamma method:

L=V(t,S)−V(t+Δt,S)≈a₀+a′ΔS+ΔS′AΔS formula 24

The a₀ in the formula 24 is a scalar. The a is an one-dimensional vector a=(a₁, . . . , a_{d})′, which is a first partial derivative of the portfolio value V with respect to the underlying risk factors S. The A=[Aᵢⱼ] is a two-dimensional (d*d) matrix, which is the second partial derivative of the portfolio value V. Therefore, all derivatives are evaluated at an initial point (t, S). In real implementations, the parameters a₀, a, and A are given as known values. It is noted that the L in the formula 24 is modeled via a quadratic function in ΔS. Therefore, L is also known as a quadratic portfolio, which is for calculating risk measures for the portfolio. In some embodiments, this model is particularly useful for modeling the portfolio consisted of financial derivatives.

In some embodiments, in order to capture a stylized feature of heavy tails for a change of underlying risk factors, an elliptical distribution ΔS is assumed as an affine transformation of a spherical distribution X, a calculation formula is represented as below:

ΔS=CX formula 25

The X in the formula 25 is assumed to follows the multidimensional t distribution t_{d,v}. The v is called degree of freedom or degree of volatility. The C in the formula 25 is a square root of positive definite covariance matrix E, such that Σ=C′C and C′AC=Λ is diagonalized with diagonal element λ₁, . . . λ_{d}.

In some embodiments, based on the above embodiments, the formula 24 is substituted into the formula 3, and the formula 24 is written as below:

L=a₀+a′ΔS+ΔS′AΔS=a₀+a′CX+(CX)′A(CX)=a₀+b′X+X∧X formula 26

In some embodiments, P(A) is denoted a probability of an event A.

F( [symbol] )=P(L≤ [symbol] ) formula 27

The L in the formula 27 is a cumulative distribution function of the portfolio's loss L. A confidence level a is given and belongs to (0,1). The Value-at-Risk of the portfolio's loss L at the confidence α is denoted by v_{α}, which is the smallest number such that a probability that the underlying portfolio's loss L exceeds v_{α} is at least α. In other words, the (1−α)×100% Value-at-Risk (VaR) is the a-quantile satisfying:

v_{α}=inf{ [symbol] :F( [symbol] )≥α} formula 28

In principle, α is set to be 1% for calculating adequate capital requirement, and a is set to be 0.1% for conducting stress testing.

In some embodiments, a key step in calculating VaR is to calculate the probability that the portfolio's loss L exceeds a given threshold q, and a calculation formula is represented as below:

P(L>q) formula 29

Once these probabilities for a set of thresholds are calculated accurately, the VaR can be obtained using interpolation for example. Le I_{{A}} (.) denote an indicator function with a support set A. Based on the formula 28, a probability in the formula 29 is calculated as below:

E[I_{{L>q}}(L)]=E[I_{{(a}_{₀}_{+b′X+X∧X)>q}}(X)] formula 30

The (1−α)×100% Expected Shortfall is defined as the expectation of the portfolio's loss L conditional on the portfolio's loss L exceeds the (1−α)% VaR:

ES_{α}=E[L|L>v_{α}] formula 31

The E[ξ|A] in the formula 31 denotes an expectation for a random variable ξ conditional on an event A. Based on the definition of conditional expectation, the formula 31 is rewritten as below:

$${ES}_{α} = \frac{E [ {LI}_{\{ L > {v}_{α} \}} ( L ) ]}{P ( L > {v}_{α} )} = \frac{E [ {LI}_{\{ L > {v}_{α} \}} ( L ) ]}{α} \qquad formula 32$$

In order to obtain ES_{α}, the numerator of the formula 32 with formula 26 is rewritten as below:

E[LI_{{L>v}_{_{α}}_{}}(L)]=E[I_{{(a}_{₀}_{+b′X+X∧X)>v}_{_{α}}_{}}(X)] formula 33

In some embodiments, critical finance risk indicator includes the Value-at-Risk and the Expected Shortfall.

In some embodiments, the VaR-related quantity, P(L>q), equals as below:

[symbol]

(L)=E(I{L>q}(L)) formula 34

In some embodiments, the expected shortfall-related quantity is:

E(LI{L>q}(L)) formula 35

Therefore, both the Value-at-Risk and Expected Shortfall need to calculate expectations of the form:

E[ [symbol] (L)]=E[ [symbol] (a₀+b′X+X∧X)]=E[ [symbol] (X)] formula 36

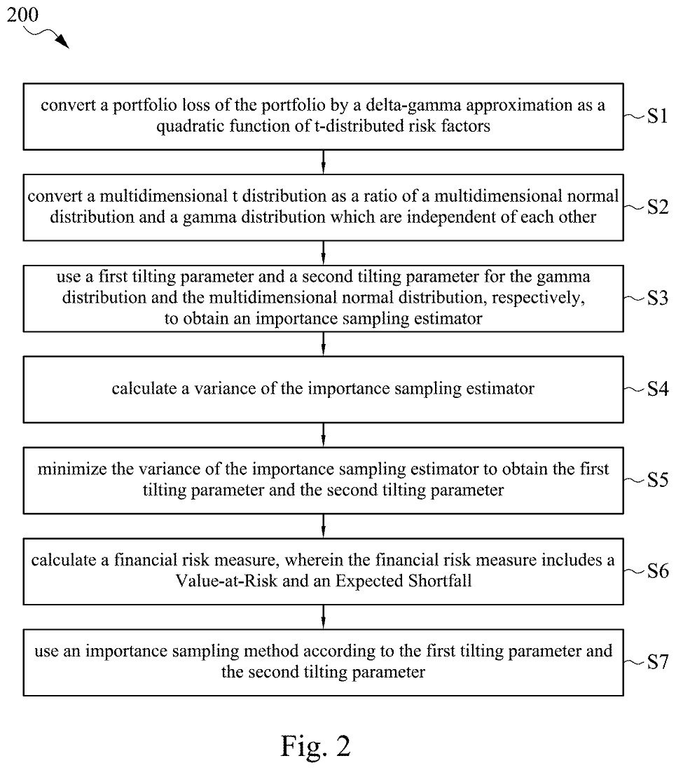

FIG. 2 depicts a flow chart of a method for evaluating risk measures for the portfolio according to one embodiment of the present disclosure. In order to facilitate the understanding of the method 200 for evaluating risk measures of the present disclosure 200, please refer to FIG. 1 and FIG. 2, the method 200 for evaluating risk measures of the present disclosure can be executed by a portfolio evaluating device 100 shown in FIG. 1.

The step S1 is performed to convert a portfolio loss of the portfolio by a delta-gamma approximation as a quadratic function of t-distributed risk factors.

The step S2 is performed to convert a multidimensional t distribution as a ratio of a multidimensional normal distribution and a gamma distribution which are independent of each other.

The step S3 is performed to use a first tilting parameter and a second tilting parameter for the gamma distribution and the multidimensional normal distribution, respectively, to obtain an importance sampling estimator.

The step S4 is performed to calculate a variance of the importance sampling estimator.

The step S5 is performed to minimize the variance of the importance sampling estimator to obtain the first tilting parameter and the second tilting parameter.

The step S6 is performed to calculate a financial risk measure, wherein the financial risk measure includes a Value-at-Risk and an Expected Shortfall.

The step S7 is performed to use an importance sampling method according to the first tilting parameter and the second tilting parameter.

In some embodiments, a finance risk indicator includes the Value-at-Risk and the Expected Shortfall.

In some embodiments, the portfolio loss is approximated by the quadratic function of t-distributed risk factors. Once the multidimensional t distribution is converted as the ratio of the gamma distribution and the multidimensional normal distribution, exponential tilting parameters are employed. The first tilting parameter is for the gamma distribution and the second tilting parameter is for the multidimensional normal distribution.

In some embodiments, the first tilting parameter is employed for the gamma distribution. The second tilting parameter is employed for the multidimensional normal distribution.

In some embodiments, the first tilting parameter and the second tilting parameter is searched by the stochastic fixed-point-Newton algorithm.

In some embodiments, expected values are calculated according to the first tilting parameter and the second tilting parameter. A sum of squared errors is calculated according to the expected values, the first tilting parameter, and the second tilting parameter. A given precision level is matched according to the sum of squared errors so as to obtain the first tilting parameter and the second tilting parameter. Target expected values are calculated with the importance sampling estimator according to the first tilting parameter and the second tilting parameter.

In some embodiments, the expected values are calculated according to a sampling probability using the first tiling parameter and the second tiling parameters for a distribution Y and a distribution Z, respectively.

Although the present disclosure has been described in considerable detail with reference to certain embodiments thereof, other embodiments are possible. Therefore, the spirit and scope of the appended claims should not be limited to the description of the embodiments contained herein. The aforementioned method can be applied for evaluating a Value-at-Risk of portfolio or other financial applications.

Based on the above embodiments, the present disclosure provides a method for evaluating risk measures for portfolio and a portfolio evaluating device so that sampled samples can be accurately calculate to approximate the values of the Value-at-Risk and the Expected Shortfall, computing time can be reduced, and efficiency of calculating the Value-at-Risk and the Expected Shortfall can be improved so as financial risk could be better managed in the bank industry.

It will be apparent to those skilled in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. A method for evaluating risk measures for a portfolio, comprising:
converting a portfolio loss of the portfolio by a delta-gamma approximation as a quadratic function of t-distributed risk factors;
converting a multidimensional t distribution as a ratio of a multidimensional normal distribution and a gamma distribution which are independent of each other;
using a first tilting parameter and a second tilting parameter for the gamma distribution and the multidimensional normal distribution, respectively, to obtain an importance sampling estimator;
calculating a variance of the importance sampling estimator;
minimizing the variance of the importance sampling estimator to obtain the first tilting parameter and the second tilting parameter;
calculating a financial risk measure, wherein the financial risk measure comprises a Value-at-Risk and an Expected Shortfall; and
using an importance sampling method according to the first tilting parameter and the second tilting parameter.

2. The method for evaluating risk measures for the portfolio of claim 1, wherein a finance risk indicator includes the Value-at-Risk and the Expected Shortfall.

3. The method for evaluating risk measures for the portfolio of claim 2, wherein the portfolio loss is approximated by the quadratic function of t-distributed risk factors, wherein once the multidimensional t distribution is converted as the ratio of the gamma distribution and the multidimensional normal distribution, exponential tilting parameters are employed, wherein the first tilting parameter is for the gamma distribution and the second tilting parameter is for the multidimensional normal distribution.

4. The method for evaluating risk measures for the portfolio of claim 3, wherein using the first tilting parameter and the second tilting parameter for the gamma distribution and the multidimensional normal distribution, respectively, to obtain the importance sampling estimator comprises:
employing the first tilting parameter for the gamma distribution, and employing the second tilting parameter for the multidimensional normal distribution.

5. The method for evaluating risk measures for the portfolio of claim 4, wherein minimizing the variance of the importance sampling estimator to obtain the first tilting parameter and the second tilting parameter comprises:
searching the first tilting parameter and the second tilting parameter by a stochastic fixed-point-Newton algorithm.

6. The method for evaluating risk measures for the portfolio of claim 5, wherein searching the first tilting parameter and the second tilting parameter by the stochastic fixed-point-Newton algorithm comprises:
calculating expected values according to the first tilting parameter and the second tilting parameter;
calculating a sum of squared errors according to the expected values, the first tilting parameter, and the second tilting parameter;
matching a given precision level according to the sum of squared errors so as to obtain the first tilting parameter and the second tilting parameter; and
calculating target expected values with the importance sampling estimator according to the first tilting parameter and the second tilting parameter.

7. The method for evaluating risk measures for the portfolio of claim 6, wherein calculating the expected values according to the first tilting parameter and the second tilting parameter comprises:
calculating the expected values according to a sampling probability using the first tiling parameter and the second tiling parameter for a distribution Y and a distribution Z, respectively.

8. A portfolio evaluating device, comprising:
a memory, configured to store an instruction; and
a processor, configured to execute the instruction in the memory so as to complete following steps:
converting a portfolio loss of a portfolio by a delta-gamma approximation as a quadratic function of t-distributed risk factors;
converting a multidimensional t distribution as a ratio of a multidimensional normal distribution and a gamma distribution which are independent of each other;
using a first tilting parameter and a second tilting parameter for the gamma distribution and the multidimensional normal distribution, respectively, to obtain an importance sampling estimator;
calculating a variance of the importance sampling estimator;
minimizing the variance of the importance sampling estimator to obtain the first tilting parameter and the second tilting parameter;
calculating a financial risk measure, wherein the financial risk measure comprises a Value-at-Risk and an Expected Shortfall; and
using an importance sampling method according to the first tilting parameter and the second tilting parameter.
